(19) United States
(12) Patent Application Publication
(10) Pub. No.: US 2007/0213991 A1
(43) Pub. Date: Sep. 13, 2007

(54) Method for buying items using SMS or MMS in a mobile telecommunication network

(76) Inventor: Joseph Bramante, Sumirago (Varese) (IT)

Correspondence Address: PEARNE & GORDON LLP, 1801 EAST 9TH STREET, SUITE 1200, CLEVELAND, OH, 44114-3108, US

(21) Appl. No.: 11/370,306

(22) Filed: Mar. 8, 2006

(51) Int. Cl. G06Q 10/00

(52) U.S. Cl. 705/1; 709/223

(57) ABSTRACT

A method for buying items using SMS or MMS in a mobile telecommunication network has been provided. After receiving a SMS or MMS on a mobile phone containing information about the item which can be bought, the user selectively presses a key on the mobile phone for either asking for further information on the item to be bought, requesting to buy the item, or requesting not to receive any further information on the good to be bought.

### BACKGROUND OF THE INVENTION

The present invention relates to a method for buying items, particularly but not exclusively CD or DVD using SHORT MESSAGE SERVICE (SMS) or MULTIMEDIA MESSAGING SERVICE (MMS) in a mobile telecommunication network.

The method according to the invention can be easily implemented in the mobile telecommunication networks presently existing without substantial changes and without the need of developing new technologies.

Presently it is known in the market a method for buying items and in particular multimedia objects such as CD's, DVD's, cassettes in which such products are advertised on telecommunication network such as a television or radio; product information, costs and also a telephone number is given so as the product can be ordered by simply calling in an easy way.

It is clear that such a sale is easy to be performed and does not need any direct retail intermediation.

In other words, retail costs can be saved and therefore the product can be sold at a convenient price.

By contrast it is to be noted that advertising has to be obviously paid and typically advertising costs, especially television advertising costs, are not so low.

Moreover advertising messages can reach several consumers but can not ‘select’ a peculiar group or identify and reach a definite kind of consumers having predetermined features.

In other terms it is not possible to send dedicated advertising messages to the final consumer (for example sending classical music CD advertising to consumers being 30 to 40 years old or cartoon DVD to people being less than 16 years old).

### SUMMARY OF THE INVENTION

In this situation it is a main aim of the present invention to solve the above mentioned drawbacks.

It is the first goal of the present solution to identify a method for buying items using SMS or MMS in a mobile telecommunication network which allows advertising the product and permits to obtain the sale of the same substantially with existing devices.

It is another object of the present invention to provide a method for buying items easy to be implemented and capable of maintaining costs of the product to be sold as low as possible.

A further object of the present solution is the possibility to select the consumers to whom the advertising messages have to be sent to.

The above and still further aims that will became more apparent in the course of the following description are achieved by a method for buying items using SMS or MMS in a mobile telecommunication network having the steps set out in claim 1 and in the claims depending thereon.

Further features and advantages will be best understood in the detailed description of the preferred, but not exclusive embodiment of a method for buying items in accordance with the present invention.

### BRIEF DESCRIPTION OF THE DRAWINGS

The embodiment of the invention will be discussed hereunder in detail with reference to the accompanying drawings.

FIG. 1 is a schematic and general view showing the method for buying items in accordance with the present invention;

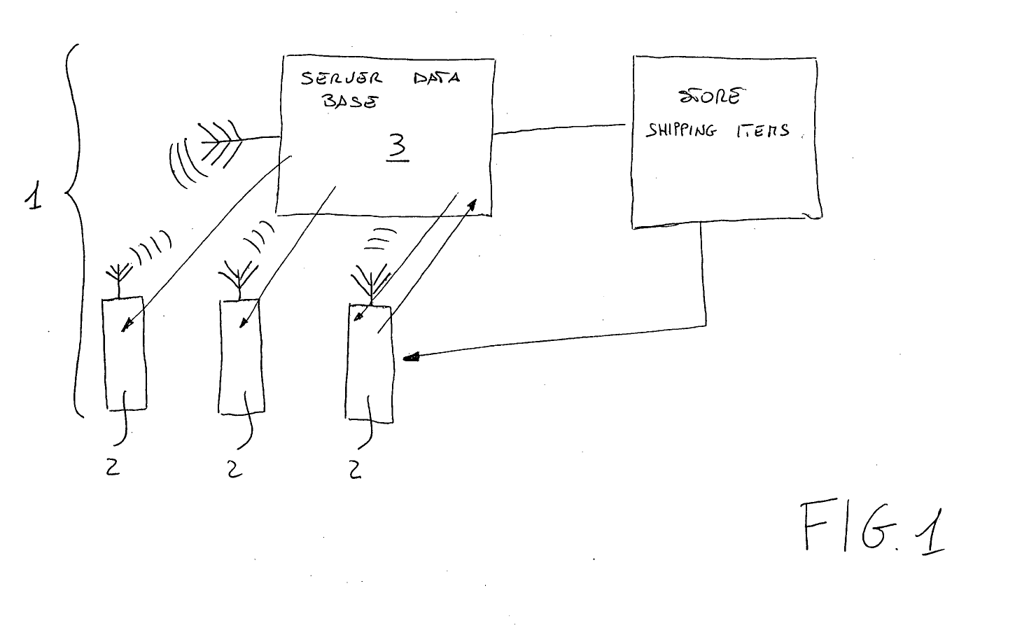

FIG. 2 is a flow chart describing the method in its fundamental steps.

### DETAILED DESCRIPTION OF PREFERRED EMBODIMENTS

The method for buying items in accordance with the present invention uses short message system (SMS) or multimedia messaging service (MMS) of the type presently known and used for exchange of messages or other multimedia contents between mobile phones.

A known mobile telecommunication network 1 is made of a plurality of cellular 2 which can communicate with at least the central server 3 (server data base) in a bidirectional way.

It is clear that the mobile telecommunication network is presently absolutely known and therefore not described in further detail.

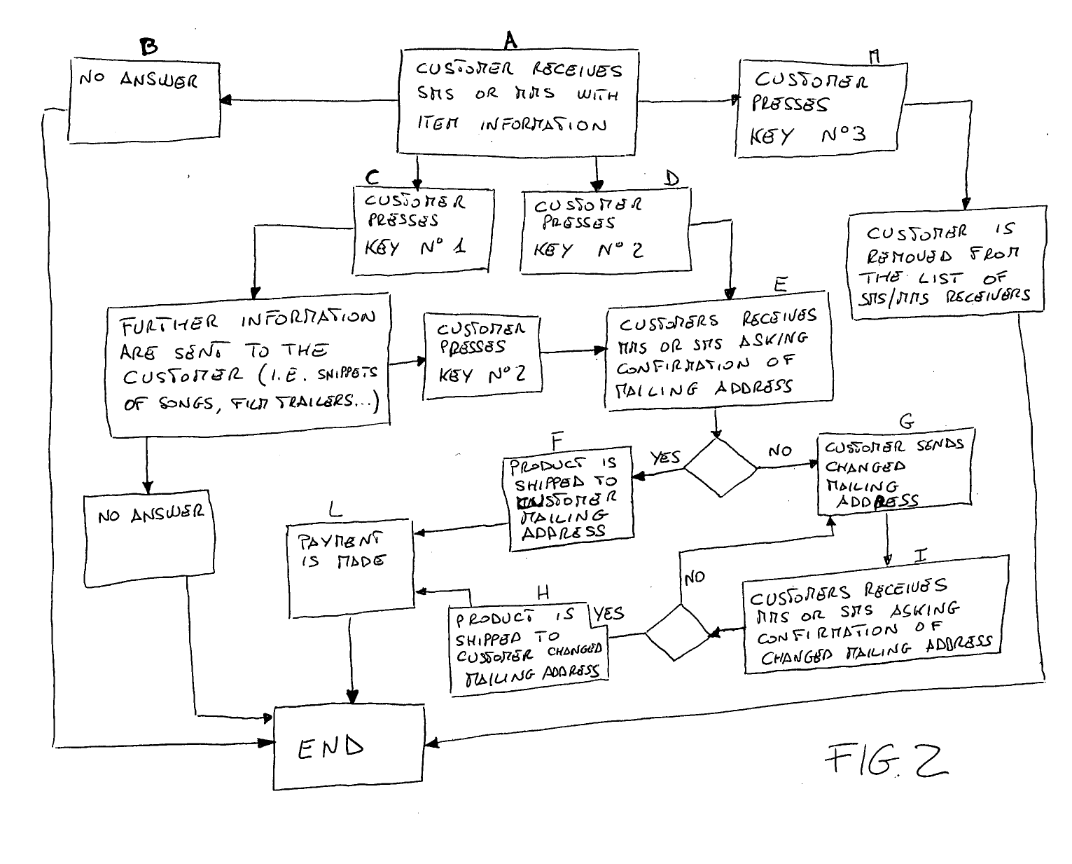

First of all the consumer will receive a message on his or her mobile telephone (Step A-FIG. 2).

In particular such a message is in the form of an SMS or an MMS and contains information about at least an item which can be bought.

Obviously the telephone does not have to be a specific mobile phone since any mobile phone will make due.

In particular the message received contains advertising and product information such as the costs for buying; for example SMS received may be of the type “New music CD-Simple Minds released, buy the CD for 9.99 dollars plus shipping”.

After receiving the message, the consumer can perform different activities.

First of all no answer can be made to the received message (Step B-FIG. 2).

In this case the original sender will not perform any further step and the process ends.

The consumer will receive further messages relating to the same item or to different items in the future.

Vice versa the consumer may perform at least three different kinds of operations.

First of all the consumer may selectively press a single key on the mobile phone. The single key to be pressed is chosen among at least a first, a second and a third key already present on a touch pad of the mobile phone.

By pressing key number 1 (for example) on the mobile telephone the consumer asks for further information of the item to be bought (Step C-FIG. 2).

In case the item to be bought is a CD, pressing key number 1 will, for example, allow the consumer to listen to some sample tracks; the tracks can be snippets of the album with the length of 15 to 20 seconds each.

In case of a DVD sale, by pressing key number 1, the consumer may for example be allowed to watch a snippet of a film or a trailer of the same.

Obviously further and different information may be given depending of the item nature (time for shipping, prices and discount, quantity available . . . ).

In detail by pressing key number 1 on the mobile telephone, the key 1 will give signal by its tone to dial up an SMS number as an automatic reply and connect the telephone to a main server 3 that will identify the number as a message to give the client options to receive further information (to listen to music tracks, . . . ) for example in CD listening situation and while in that mode, the same would apply for the individual tracks to listen with the key touch identifying tone system that will act as an automatic tone and track separator for the customer to scroll through the separate 19 seconds of sampled music of the individual tracks.

In other words again the software program will provide a code for 1; when 1 is pressed the phone automatically will ring to a listening center; pressing 1 number rings to listen in center, when automatically answered it will give a selection of tracks to listen to by pressing the touch pad on the telephone that the consumer or client is using.

As a different option with respect to the above mentioned, the client can selectively press a different single key on the mobile phone causing the request to buy the item (Step D-FIG. 2).

After exclusively pressing said key, for example key number 2, a request to buy the item via SMS or MMS is returned to the main server or processing the request. In particular the SMS or MMS is returned either to the original sender or to another database server which can be either the telephone company database or the seller server database where the order can be processed.

Server database can obviously identify the mobile phone owner and will then send a further SMS or MMS to the mobile telephone owner to confirm a mailing address where to receive the item (Step E-FIG. 2).

In particular the confirmation message will contain the mailing address that is acquired through the telephone company's registry of that particular SIM card (Subscriber identity module) customer details.

The customer returns the SMS or MMS confirming or changing the mailing address.

The sellers then receive the confirmation; if the confirmation returns with no change of address then the order is shipped to the registered client's address that is noted with the telephone company (Step F-FIG. 2).

If vice versa the address is not correct, the customer will send back the address with the right mailing address and then the order is processed to such corrected mailing house (Steps G, H-FIG. 2).

Obviously the customer will receive a further SMS or MMS asking confirmation of the changed mailing address (Step I-FIG. 2)

In other words by pressing the key number 2 on the mobile telephone, same key number 2 will give a signal (tone) that will identify the tone as a dial up for the purchase of the item; once received in the data bank as a purchase, the program will then automatically send the cited confirmation message for the confirmation of the mailing address.

The user can also opt for “no pricetag” or “gift” to the seller ship the item with no price indicated, so that the user can send it as a gift to another person.

The customer by pressing key number 4 on the phone (for example) will confirm the order and at the same time a message to an other data internal system is sent to identify the debit and then to process the order.

Payment can be made in any way (Step L-FIG. 2) but it is preferably deducted automatically whether by debit card or by monthly billing; moneys are then processed on a daily or on a monthly base, depending on the contractual obligation with the specific telephone company and then credited companies/persons.

As a further possible option, the customer can press different single key on the mobile phone (for example key number 3) in order to request not to receive any further information on items to be bought (Step M-FIG. 2).

In other words pressing key number 3 will confirm that no other messages are desired.

Again the software program will provide a code for 3, when 3 is pressed it automatically will ring to a data system that will separate the different type of product commerce that is solicited and then will bank them as they are processed.

Obviously the software can be made to tailor the existing SMS centre units, or can be made to tailor customized database system that can be worked into collaboration with telephone companies.

At the same time the sellers can directly send the SMS apart from the use of the telephone companies and work out the payment procedure to fit the requirements that whether the telephone companies or the merchandiser accounts.

The method also applies but is not limited to the use of Java in modern mobile phones.

In the process the user agrees to get a short program, that is downloaded to his telephone, which can then be directly contacted by the database. He can then reply with just one, two, three or four and we associate the appropriate function to their key pressing.

System and method achieve important advantages.

The above described system is substantially like a telephone credit card type of system; it can work for any product, i.e., the advertising SMS message can regard flowers, food, clothes and the same system applies for payment.

In case of MMS, customer can receive album covers and tracks to listen to and therefore the use of MMS system allows receiving more detailed information of the product.

The payment by phone system relies on a program that automatically launches SMS messages, behind SMS is a return number with a carry code to identify whether the code is, for example, 1 to listen, 2 to buy, 3 not to receive messages any longer.

All the key numbers have identifying codes that will process made to fit whether working with the database system that the telephone company has existing through the SMS servers that are spread all over each Country or can be used for the customized telephone database system.

Obviously market opportunities of the above mentioned method are with substantially no limit since the method can be applied to presently existing mobile telecommunication networks without any substantial technological modification.

Moreover it would also be possible to create a credit card that would be used for all purchases over the SMS system.

Costs for implementing and for selling are obviously reduced due to the fact that telecommunication networks exist and products can be directly sold to consumers without using retailers or passing through a market.

1. Method for buying items using SMS or MMS in a mobile telecommunication network comprising the following steps:
receiving a SMS or a MMS on a mobile phone containing information about at least an item which can be bought;
selectively pressing a single or few key[s] on the mobile phone, said pressing causing the mobile phone to send back a SMS or a MMS or an information which either:
asks for further information on the item to be bought;
requests to buy the item;
requests not to receive any further information on the item to be bought.

2. Method according to claim 1 wherein said single key to be pressed is chosen among at least a first, a second and a third key already present on a touch pad of the mobile phone.

3. Method according to claim 2, wherein, after exclusively pressing said second key and sending an SMS or a MMS, a request to buy the item via SMS or MMS is sent to a server database processing the request;
the server database identifying a mobile phone owner and providing for shipping the item to the address indicated by the mobile telephone owner.

4. Method according to claim 3 wherein after identifying the mobile telephone owner a further SMS or MMS is sent to the mobile telephone owner to obtain confirmation of a mailing address where to receive the item.

5. Method according to claim 3 wherein, after exclusively pressing said second key a request to buy the item via SMS or MMS is returned to an original sender processing the request; the original sender identifying the mobile telephone owner and sending the further SMS or MMS to confirm the mailing address.

6. Method according to claim 5 wherein after exclusively pressing said second key the request to buy the item via SMS or MMS is automatically returned to sender database processing the request.

7. Method according to claim 5 wherein the mobile telephone owner returns the SMS or MMS to the original sender either confirming or changing the mailing address.

8. Method according to claim 5 wherein the original sender ships or provides for the shipping of the item to the mailing address in case SMS or MMS received confirm the mailing address, the original sender sending back a SMS or MMS with a changed mailing address in case SMS or MMS received changes the mailing address.

9. Method according to claim 8 wherein the mobile telephone owner returns the SMS or MMS to the original sender confirming the changed mailing address, the original sender processing the order to said changed mailing address.

10. Method according to claim 1 wherein the method further comprises the step of automatically debiting an amount due for buying the item by debit card or billing or directly on a rechargeable account.

11. Method for buying a CD or a DVD using SMS or MMS in a mobile telecommunication network comprising the following steps:
receiving a SMS or a MMS on a mobile phone containing information about at least a CD or a DVD which can be bought;
selectively pressing a single key on the mobile phone, said pressing causing the mobile phone to send back a SMS or a MMS which either:
asks for further information on CD or DVD to be bought;
requests to buy the CD or DVD;
requests not to receive any further information on the CD/DVD to be bought.

12. Method according to claim 11 wherein when further information is asked on CD or DVD, the original sender sends or provides for sending a selection of tracks of the CD to listen to or sends or provides for sending a trailer of the DVD.
